(19) United States
(12) Patent Application Publication
(10) Pub. No.: US 2026/0121963 A1
(43) Pub. Date: Apr. 30, 2026

(54) CONVERGENCE OPTIMIZATION IN NETWORKS

(71) Applicant: MELLANOX TECHNOLOGIES, LTD., Yokneam (IL)

(72) Inventors: Donald Sharp, Apex, NC (US); Evgeny Tantsura, Emerald Hills, CA (US); Karthikeya Venkat Muppalla, San Jose, CA (US); Vijayalaxmi Basavaraj, San Jose, CA (US); Vivek Venkatraman, San Ramon, CA (US)

(21) Appl. No.: 19/317,016

(22) Filed: Sep. 2, 2025

Related U.S. Application Data
(60) Provisional application No. 63/712,333, filed on Oct. 25, 2024.

(51) Int. Cl. H04L 45/02; H04L 45/17; H04L 45/28; H04L 65/102

(52) U.S. Cl. CPC H04L 45/02; H04L 45/17; H04L 45/28; H04L 65/102

(57) ABSTRACT

Systems and methods herein are for a network having a receiver network device and a source network device. The source network device may be configured to advertise a route comprising an attribute and at least one network address that is representative of the source network device. The attribute may include an identifier of the source network device and the at least one network address having a prefix associated with hosts of the source network device.

The receiver network device may determine a convergence for routing packets from the receiver network device based in part on a determination that the identifier matches at least the prefix of the route advertised by the source network device. Convergence determinations can be faster when performed using only the one route update having the identifier that matches at least the prefix, which allows the receiver network device to recognize and use only one route update.

### CROSS-REFERENCE TO RELATED APPLICATIONS

This is a Non-Provisional Patent Application which is related to and which claims the benefit of priority to U.S. Provisional Patent Application 63/712,333, filed on Oct. 25, 2024, and entitled “CONVERGENCE OPTIMIZATION IN NETWORKS,” which is hereby incorporated by reference herein in its entirety and for all intents and purposes.

### TECHNICAL FIELD

This disclosure generally relates to convergence optimization in networks and specifically relates to covergence using route grouping in networks.

### BACKGROUND

Convergence as used herein may be in reference to a process by which individual network devices use shared route information or updates to determine a consistent state within itself with respect to a network topology, such that the packets provided from the individual network devices are properly routed and reach intended network devices and/or hosts. The optimizing of the convergence determinations may be in reference to a speed with which individual network devices can adapt to changes (such as failures within the network). Upon failures in a nework, multiple routing updates may be provided to the network devices and may required more convergence determinations to be performed. This may result in the network devices being occupied and may result in packets losses (or dropped packets). Packet losses may cause severe performance degradation and may increase job completion time (JCT) for certain workloads, such as for artificial intelligence/machine learning (AI/ML) workloads, which may use JCT as a metric for performance.

### BRIEF DESCRIPTION OF DRAWINGS

FIG. 1 illustrates a network that is subject to embodiments for convergence optimization in networks;

FIG. 2 illustrates leaf-spine network subject to route updates, according to at least one embodiment;

FIG. 3 illustrates aspects of convergence optimization for failures using an attribute and at least one network address, according to at least one embodiment;

FIG. 4 illustrates computer and processor aspects of a system for convergence optimization using an attribute and at least one network address, according to at least one embodiment;

FIG. 5 illustrates a process flow in a system for convergence optimization using an attribute and at least one network address, according to at least one embodiment;

FIG. 6 illustrates yet another process flow in a system for convergence optimization using an attribute and at least one network address, according to at least one embodiment; and

FIG. 7 illustrates a further process flow in a system for convergence optimization using an attribute and at least one network address, according to at least one embodiment.

### DETAILED DESCRIPTION

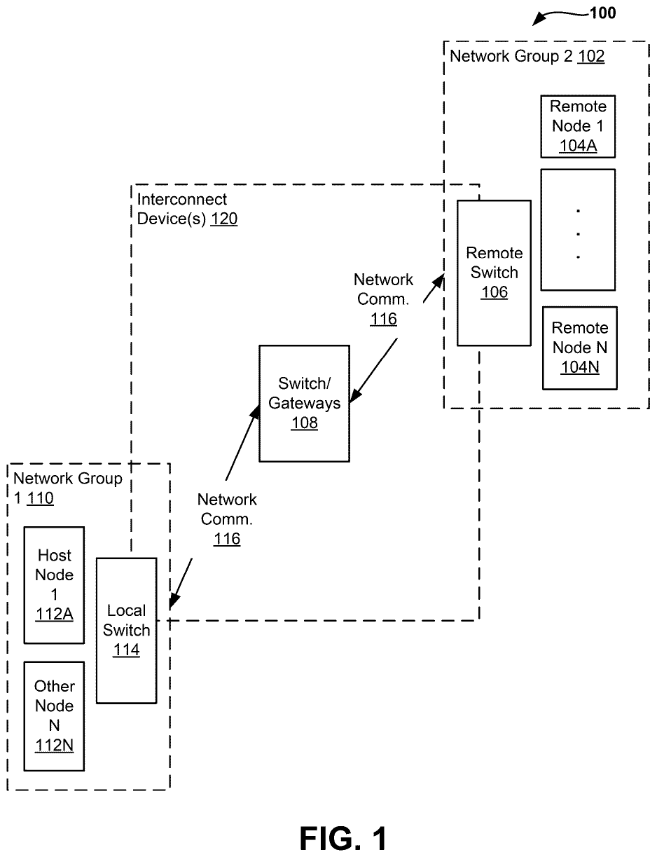

FIG. 1 illustrates a network that is subject to embodiments for convergence optimization in networks, as detailed herein. In one example, the network 100 is subject to the Border Gateway Protocol (BGP). Convergence determinations in network devices, such as routers, switches 106, 114, gateways 108, or other interconnect devices 120 may use network information including source identifiers. To support optimizing of convergence determinations in a network 100, such as a leaf-spine network that may be compliant with BGP, a source network device (such as a first leaf switch or other network device) may be configured to advertise a route sharing an attribute (such as a route origin extended community provided within BGP under the RFC4360 Standard, at section 5). A route having a route origin advertised may be an anchor route. The route advertised may also include at least one network address that may be representative of the source network device. The attribute may be the source identifier (also referenced as an identifier) and may be an internet protocol (IP) address of the source network device. Within at least BGP, the identifier may be a route-identifier or a route originator identifier (ID). The at least one network address may a prefix associated with hosts that are behind, or that are limited in representation by, the source network device. For example, the hosts are represented by only one leaf switch.

The IP address of the source network device may match the prefix, at least because the IP address may be used for internal management in the source network device and the prefix may represent a root of all the hosts behind the source network device. The IP address may be advertised via the attribute to support the convergence determinations herein. In an example using BGP, frequent route updates may be provided by one or more network devices 106, 108, 114, 120 of the network 100 upon failures that may occur in the network 100. The failures may be with respect to a link between the devices that has failed or individual devices that has failed, where a failure may be an inability to properly route packets. The matching of the IP address to the prefix, as advertised, may be used by a receiver network device during a failure to update its routing information by recognizing the source network device alone (from the attribute) and ignoring all other route updates from the source network device.

In some examples, with respect to at least BGP, there may be a latency or time requirement which drives the convergence, following a failure or a change made in the network. In some examples, the latency or time requirement may be at least in part due to processes required to determine routes following the failure and to advertise new routes to network devices in the network. The latency or time requirement is proportional to the number of routes, as it is performed route-by-route and is compute intensive. The convergence performed herein may be an optimization, also referred to as convergence optimization, to the route-by-route related compute requirement. For example, instead of route-by-route changes, a grouping of the routes may be performed. The grouping of routes may be performed so that the routes (including any network device associated with the routes, such as leaves, spines, and super spines within the routes) may be grouped together or related together using the identifier, such as the route-originator identifier. The grouping may allow changes to be propagated to the groups instead of being propagated route-by-route. In some examples, when routes are determined as associated together to form a group, one next-hop group (NHG) change may be performed for the entire group instead of the route-by-route changes.

As route updates within the receiver network device may require performing convergence determinations for every route update, there may be multiple route updates (such as one advertised route per host behind the source network device) otherwise required to be performed in the receiver network device. This may be the route-by-route process which may cause significant delays or may result in excessive processing in the receiver network device, without regard to routing packets. With an ability to apply convergence determinations to only one route update, which has an IP address matching its prefix, a receiver network device may ignore all other route updates from the same source network device. This may be at least because the failure associated with the source network device may likely affect all the hosts behind the source network device and so, the convergence determinations using the one route update can apply to all the hosts for the source network device. As a result, the convergence determinations may be faster, and the network devices may be freed up to perform routing of packets.

In addition, to support the route updates used for convergence determinations, the receiver network device may be further configured to assign a NHG for the source network device. Individual NHGs may be provided for individual network devices. Upon a failure associated with the source network device, the NHG may be subject to a replacement operation for all prefixes previously associated with the source network device independent of individual route updates from the source network device. In addition, at least one NHG of a different source network device that is not part of a failure in the network remains unchanged. This also reduces latency and delays in a network 100 following the failure and the requirement for route updates to be propagated and applied within the network 100.

Convergence optimization herein may be enabled, in part, in two steps. Initially, an assignment of at least one NHG per source may be performed, followed by enabling leaves in a leaf-spine network, for instance, to advertise the identifier of the source network device. The identifier provided in the attribute part of an advertisement may be the router-identifier logical IP address (such as a router-identifier loopback route) advertised from a leaf. A leaf may additionally tag prefix routes with the route origin extended community when BGP is used with the leaf-spine network. This enables other leaves to recognize the source of the advertisement. Additionally, the router-identifier logical IP address may be sent and received first in a communication of route updates, which allows receiving network devices to perform a convergence determination during failures, irrespective of any number of further route updates received from the source network device. In one instance, instead of failures, when a network topology changes, a leaf that is a receiver network device may receive the router-identifier logical IP address as a route update with an updated enhanced multipath control protocol (ECMP). The updated ECMP or weighted-ECMP part may allow an NHG to be subject to the replacement operation for all prefixes from the source network device without waiting for individual route updates.

In one example, the network 100 may include at least one circuit that may be an execution unit of a processor that may be within a switch 106; 114, any one of different interconnect devices 120, or first or second group nodes 1-N 104A-N; 1-N 112A-N. An interconnect device may allow communication across a wider network group and may include different switches and/or gateways 108, whereas communications in a narrower network group or within a network group may be enabled by at least one switch 106, 114. Further, the switches may communicate with each other independent of the nodes to share configuration information for various routes in the network 100.

The switch 106; 114 may be associated with a respective one rack, chassis, or other form of a physical collection illustrated as network group 2 102; 1 110 of nodes or other endpoints 1-N 104A-N; 1-N 112A-N, as illustrated. The convergence optimization using an attribute and at least one network address may be performed for one or more of the network devices 106, 108, 114, 120. The network 100 may include at least a switch or gateway 108, as part of one or more interconnect devices 120, to provide communications 116 between multiple switches 106, 114 and, therefore, between the first or second group nodes 1-N 104A-N, 1-N 112A-N across a wider network group. The approaches for convergence optimization using an attribute and at least one network address may be performed within a network group or between network groups. Therefore, descriptions herein to an interconnect device 120 may be understood as applicable using any of the switches 106, 114 or gateways 108 illustrated.

In one example, the communications 116 may be Ethernet, InfiniBand® (IB), NVLink®, Bluetooth®, or any suitable communications that can benefit from the convergence optimization using an attribute and at least one network address described herein. Further, any communications network supporting BGP, including Transmission Control Protocol (TCP) or Internet Protocol (IP) on top of TCP, may be used with the convergence optimization using an attribute and at least one network address described herein. When the communications 116 is IB or NVLink, at least one of the multiple switches 106, 114 or at least one of the first or the second group nodes 1-N 104A-N; 1-N 112A-N may be able to host a Subnet Manager (SM) or any required feature for the relevant IB or NVLink protocols. Similarly, when the communications 116 are Ethernet communications, then least one of the multiple switches 106, 114 may be able to host or function as a Switch Manager (SM).

In at least one embodiment, when the network 100 is adapted for BGP, the switches 106, 114 may be spine or leaf switches. As such, each network group 2 102; 1 110 of nodes or other endpoints 1-N 104A-N; 1-N 112A-N may communicate within the group using the leaf switches 106, 114 and may communicate across groupings using spine switches or gateways 108. The convergence optimization using an attribute and at least one network address, for the network 100 in FIG. 1, may overcome technical constraints and limitations associated with convergence determinations using multiple route updates for each host behind a source network device.

In at least one embodiment, in the context of a data plane and a control plane, convergence determinations herein may extend to also include a speed at which a network is updated with correct control and data plane states, in response to changes in network topology. Therefore, convergence optimization may include individual network devices and may extend to a network. When the network is a single-hop bidirectional forwarding detection (BFD)-enabled network, local link failures may be addressed by the route updates. In BFD, in some cases, including when a physical layer has not failed but an IP layer has failed, BFD may allow for faster failure detection and hence faster convergence. This affords the BFD-enabled network with better route convergence. This may not be applicable for remote link failures in a network 100 having links that are more than a single hop away. For instance, in Clos Network topologies using an external BGP (eBGP), unicast convergence determinations may be influenced by multiple factors which may include BGP convergence time, network delay, and a processing delay within a network device associated between a control plane (providing, for instance, free range routing (FRR)) and a data plane (including associated hardware).

The network 100 in FIG. 1, having more than one hop between hosts and network devices, and being subject to convergence optimization for failures using an attribute and at least one network address, can address the issues that may otherwise occur during remote link failures. In the leaf-spine network, from a local leaf perspective, a remote link may be in reference to a link between a spine and a remote leaf or between a spine and super spine. For instance, when a remote link failure occurs, after receiving route updates due to a change in a network, a new ECMP path may not be programmed in the hardware fast enough. This may be because a route update may be provided as a per-route update within a switch and its components (such as from the BGP aspects to a Zebra® routing platform, to a kernel, to Switchd® daemon (or background process), to a software development kit (SDK), and to other hardware). Once route updates are received, a network device may be to switch or direct packets to a new route or to a same route but may use different weights and may perform the switch or direction faster, independent of a number of routes (or hosts behind a source network device, where is independence may be referred to as a prefix independent convergence).

The convergence optimization for failures using an attribute and at least one network address can address or improve unicast traffic convergence in prefix independent way (such as a prefix independent convergence or PIC). With PIC for a switch, updates to new ECMP routes may be due to changes in network topology (such as link failures). This approach may be directed to high-performance Ethernet for artificial intelligence (AI)/machine learning (ML) topologies, where convergence determinations made during link failures may be crucial.

In at least one embodiment, the convergence optimization herein may apply to Layer 3 (L3) BGP, adaptive routing traffic and non-adaptive routing traffic, remote link down and up convergence triggers, 2 CLOS or 3 CLOS topologies, and links between devices having a single link or multiple links (including to weighted equal-cost multipath (W-ECMP)) routing. The convergence optimization herein may apply to 80,000 or more routes, in one example. Although convergence optimization herein may be hardware-agnostic with respect to a type of network device 106, 108, 114, or 120, all such hardware may need to be imparted with capability to recognize the attribute, to determine the match using the attribute and the prefix in an advertised route, in case of a failure, and to perform an internal route update using the singular route update having the attribute, with any further route updates from the same source and for the same failure being subject to a null process.

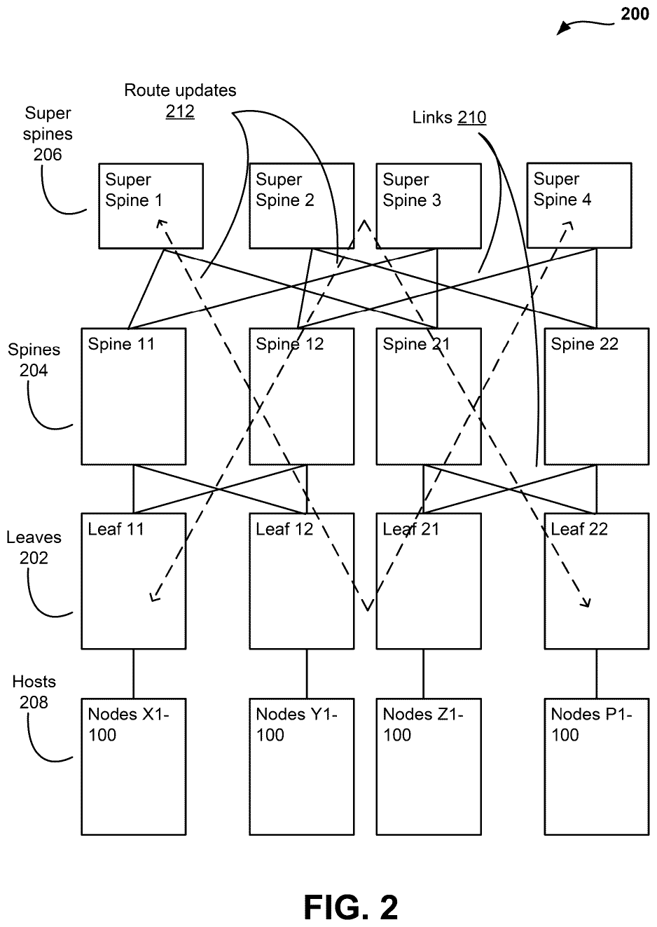

FIG. 2 illustrates a leaf-spine network 200 subject to route updates, according to at least one embodiment. The leaf-spine network 200 may be a specific configuration to the network 100 in FIG. 1. The leaf-spine network 200 may include leaves 11, 12, 21, 22 202, spines 11, 12, 21, 22 204, and super spines 11, 12, 21, 22 206. The leaves, spines, and super spines may be one of a network device 106, 108, 114, 120 described in connection with FIG. 1. The leaf-spine network 200 may be a network topology that may be commonly found in high-performance computing (HPC) systems to support high bandwidth and low latency communication between hosts 208. Such a leaf-spine network 200 may be used for applications having data-intensive processing and parallel computing, which may include distributed computing workloads.

The leaves 202 may be end nodes or switches 106, 114 that connect to hosts 208, which may be complete compute systems, or which may be individual processors or storage devices. They may also be referred to as edge devices. The leaves 202 may be responsible for routing traffic from the spines 204 and super spines 206 to the hosts 208. The leaves 202 may also be responsible for advertising prefixes learned from hosts 208 to the spine 204. The spines 204 may represent a core of the network 200 as it may connect to the super spines 206 but provide connections for the leaves 202 and exchange of routing updates or information therebetween. The spines 204 may be responsible for receiving and distributing route updates 212 from the leaves 202 using the provided links 210. The super spines 206 may be intermediate endpoints that connect the spines 204 and enable connections to the leaves 202. The super spines 206 may provide aggregation for traffic and may provide additional redundancy, where needed. The leaves 202 may be associated with each other through the spines 204 and the spines may be associated with each other through the super spines 206.

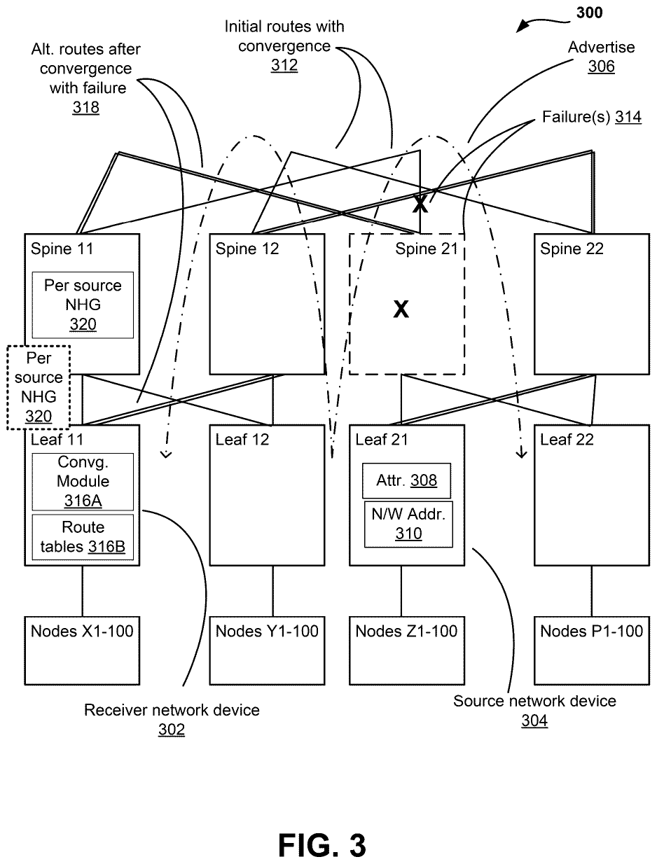

Each leaf 11, 12, 21, 22 202 may include a respective set of hosts X1-100, Y1-100, Z1-100, P1-100 that may be behind a leaf. In some examples, the hosts X1-100, Y1-100, Z1-100, P1-100 may be selected from one or more of GPUs, servers, or virtual machines (VMs). In some examples, without the advertisement from one or more of the leaves, such as a leaf 11, 12, 21, 22, each leaf may not know the locations of hosts which are not behind it. For example, leaf 11 may not know the location of hosts Y1-100 which are behind leaf 12. A leaf may have a table or other registry of the hosts associated with it, such as the hosts that are behind the leaf. A leaf may have an IP address and may have a prefix associated with it, with respect to the network 200. For instance, the IP address may be in the format of AAA.BBB.CCC.DDD, while the prefix or subnet mask may be in the format of OOO.XXX.YYY.ZZZ/PPP. Each of the alphabets may represent a number. The PPP portion of the prefix may represent a number of bits defining the prefix. As discussed with respect to at least FIG. 3, to support information about hosts behind different leaves, a network protocol, such as BGP, may use an attribute as a route origin extended community of the network protocol. The route origin may rely on a label or tag from the individual leaves and may also include identification of at least the leaf to which hosts may be coupled and which may be part of a change in the route, including a change in a network topology. In the aspects 200, the hosts are behind, or are limited in representation by, a source network device, such as a leaf switch (such as one of leaves 202). For example, the hosts are represented by only one leaf switch.

FIG. 3 illustrates aspects 300 of convergence optimization for failures using an attribute and at least one network address, according to at least one embodiment. Initially, the network illustrated may be from the leaf-spine network 200 in FIG. 2 or may be another suitable variation of the network 100 in FIG. 1 capable to providing route updates having an attribute that can include an identifier as a potential match to a prefix of an IP address from a source network device. The aspects 300 illustrate that such a network 100, 200 may include a receiver network device 202 (leaf 11) and a source network device 304 (leaf 21). The source network device 304 may be configured to advertise 306 a route (as part of a route update). The route may be route updates with respect to its connected network devices in the spines 204, other leaves 202 and/or with respect to its hosts (nodes Z1-100). In the aspects 300, the hosts are behind, or are limited in representation by, a source network device, such as a leaf switch (such as one of leaves 11, 12, 21, or 22). For example, the hosts are represented by only one leaf switch.

The route may include an attribute (attr.) 308 and at least one network address (N/W addr.) 310 that may be representative of the source network device 304. The attribute 308 may include an identifier of the source network device 304 and the at least one network address 310 may include a prefix associated with hosts (nodes Z1-100) of the source network device 304. Then, the receiver network device 302 may be configured to determine a convergence for routing packets from the receiver network device based in part on a determination that the identifier matches at least the prefix of the route advertised by the source network device 304. A route having such a match can represent the router-identifier logical IP address advertised from a leaf, such as the source network device 304.

In some examples, network protocols implementing the attribute 308, as a route origin extended community in support of the NHGs. For example, one NHG may be assigned per source of a route (referred to as a per source NHG 320 illustrated in FIG. 3). This may be so that a remote leaf, acting as the source network device, may cause, allow, or support advertising of the identifier (such as by providing the route-identifier) for an advertised route. The advertised route may include or may be based on a loopback route. For example, the remote leaf may tag or label prefix routes, as part of the identifier being advertised, The prefix routes may be referenced by the identifier within a route-origin extended community for a local leaf to recognize them. Additionally, the identifier may be sent and may be received within a network prior to a convergence determination to allow or support quick convergence determinations during failures. In some examples, when a network topology changes, a local leaf may receive an identifier of a loopback route with updated ECMP. This may allow one NHG to replace operation for all prefixes from the remote leaf, without waiting for individual BGP updates which may be applicable in a route-by-route process.

In some examples, every spine and every leaf may receive and update routes using the identifier as received from a remote leaf. As such, every spine and every leaf may be able to receive and update routes, within hash tables, route tables, or other suitable references, faster and with more efficiency to support convergence for changes that may occur within a network. In some examples, every leaf and spine, such as from a source network device, may include the identifier (such as the route originator ID, which may be unique for the source network device). On the receive side, when a leaf or a spine receives an identifier indicative of a change to a network topology, then the leaf or spine which may include a receiver network device may create an NHG to associate with the identifier, as part of a configuration within the receiver network device. In some examples, the updates to the routes may also be available within the super spines illustrated in FIG. 2.

In at least FIG. 3, a per source NHG 320 may be created or may apply where a route originates. This may be so that when a remote link (route) fails within a network and as mapped in a network topology, FRR may be used to perform an NHG replace operation. The NHG replace operation may apply to only impacted routes behind the remote leaf, which is impacted. In some examples, a route originator ID is associated with an NHG which represents two or more routes. The two or more routes may include routes between one or more of leaves to hosts, leaves to spines, or spines to super spines. As such, a per source NHG 320 is created for only an NHG and not for individual next-hops (such as for next-hop IDs). The change in the network topology may cause a change in the NHG. The change in the NHG allows the two or more routes under the NHG to be changed to use different ones of the network devices associated with the NHG from an initial ones of the network devices. In the example in FIG. 3, Y1-100, Z1-100, P1-100 routes may originate from leaf 12, leaf 21, and leaf 22 respectively. The BGP protocol on these leaves may advertise their routes with a route originator ID or a site-of-origin (SOO) inclusion within the route origin extended community of the BGP protocol. A similar advertisement may proceed with other network protocols capable of advertising routes and using extended community or other messaging. Changes from the route origination may be performed by attaching the route origin extended community. On a receiving node or network devices, such as leaf 11, an allocation of a per source NHG 320 may be made to receive and apply any changes, such as using the convergence module 316A and routing tables 316B.

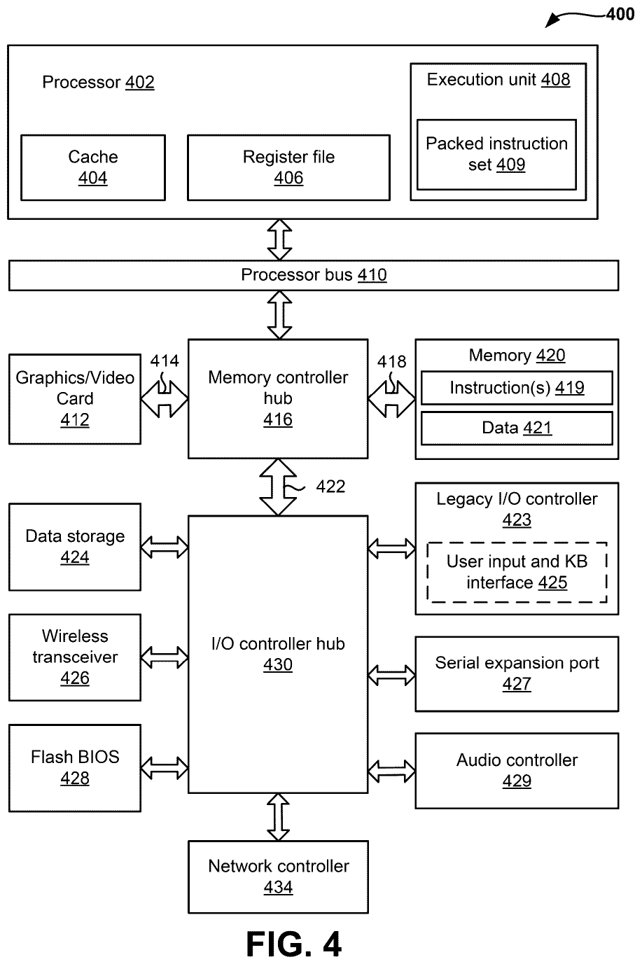

In some examples, every spine 11-22 and every leaf 11-22 may be a network device, such as a switch. The network device may include one or more circuits. The one or more circuits may include processors, such as described in connection with FIGS. 1 and 4. The one or more circuits may perform convergence within the BGP protocol. The convergence may follow a change in a network topology and may group together two or more routes within the network topology with an identifier, such as a route originator ID. The route originator ID may be used as a basis to route configuration associated with network devices and associated with the two or more routes within the grouping. The configuration may include creation or association of an NHG, from the source network device, and within a receiver network device. The one or more circuits may allow the route originator ID to be associated with an NHG to represent the two or more routes. The change in the network topology may cause a change in the NHG. The change in the NHG may allow the two or more routes under the NHG to be changed using the route configuration attached to the network devices, such as the source network device and the receiver network device and associated with the NHG. In some examples, the super spines illustrated in FIG. 2 may be also a network device with the one or more circuits to perform aspects described in connection with the spines and the leaves herein.

As illustrated in FIG. 3, there may be initial routes with convergence 312 enabled by links 210 as an on-going requirement in the network 100, 200. Upon a failure 314, however, where one or more links 210 have failed or a network device (spine 21) has failed, route updates may be provided to represent each of the hosts 208 (such as nodes Z1-100) for each of the leaves 202 (such as leaf 21 forming the source network device 304). As the receiver network device 302 may already receive the route advertised 306, which may be a router-identifier logical IP address, from a source network device 304, the receiver network device 302 may determine the match inside the route. The receiver network device 302 may perform its convergence optimization in a convergence module (convg. module) 316A to skip over the failure 314 using the received single route advertised 306. While the receiver network device 302 may receive route updates that represent each of the hosts, it may ignore these or may perform a null process that does not occupy a processor other compute components of the receiver network device 302.

The doubled-line links in FIG. 3 represent the alternate (Alt.) routes after convergence upon failure 318, where this convergence represents convergence optimization for at least being based on a singular route advertised 306. These alternate routes after convergence upon failure 318 may be able to reach hosts (nodes Z1-100) behind the spine 21 and its associated leaf 21 through other an unaffected spine 12 and/or an unaffected super spine 1, 4, instead of affected spine 21 and super spine 2. Indeed, as apparent from the discussion here, the distribution of traffic may be adjusted through the unaffected routes, based in part on determinations made by the convergence module 316A and using the route advertised 306 with the matching identifier and prefix for the source network device 304.

As in the case of networks 100, 200, the illustrated aspects 300 may apply to a network which may be compliant with BGP so that the attribute is a route origin extended community of the BGP. The network in the illustrated aspects 300 may be such that the receiver network device 302 may be configured to receive indication of a failure 314 in the network and to perform the determination of the convergence for routing packets based in part on the indication of a failure in the network. The failure may be indicated from the source network device 304 or any other network device in the network.

The network in the illustrated aspects 300 may be such that the receiver network device 302 can be further configured to receive additional advertisements of routes associated with the hosts (such as nodes Z1-100) of the source network device 304. The receiver network device 302 may be further configured to perform the null process with respect to the additional advertisements from the source network device following the advertisement 306 having the route advertised by the source network device 304. In one instance, the null process may be to maintain a routing associated with the route advertised 306, without updating to the additional advertisements of routes in the convergence module 316A.

The network in the illustrated aspects 300 may be such that the receiver network device 302 may be further configured to assign an NHG for the source network device 304. The network in the illustrated aspects 300 may support individual NHGs for individual network devices represented by the leaves 202, the spines 204, and the super spines 206. Upon a failure associated with the source network device 304 (such as at a spine 21), the receiver network device 302 may be further configured to perform a replacement operation for the NHG and for all prefixes previously associated with the source network device 304. The replacement operation may be independent of individual route updates from the source network device 304.

There may be further NHGs of other source network devices in the leaves 202 of the network in the aspects 300 illustrated. The NHG created or assigned to a source network device 304, upon a failure 314, may not affect the other source network devices that are not part of the failure in the network. Therefore, the other NHGs assigned to other source network devices in the leaves 202 may remain unchanged after the failure 314. The per source NHG assigned may be performed at the spines 204 and may be performed in a per source NHG module 320 of each of the spines 204 (such as spine 11).

The aspects 300 in FIG. 3 also illustrate that each source network device 304 in a network may be configured, in part by at least software to advertise a route having an attribute and at least one network address that is representative of the source network device 304. The attribute may have the identifier of the source network device 304 and the at least one network address that may include the prefix associated with hosts (nodes Z1-100) of the source network device 304. The attribute and the at least one network address may enable a receiver network device 302 in the network to determine a convergence (such as for the alternate routes after convergence upon failure 318) for routing packets from the receiver network device 302 based in part on a determination that the identifier matches at least the prefix of the route advertised by the source network device.

Separately, the aspects 300 in FIG. 3 also illustrate that each receiver network device 302 in a network may be configured, in part by at least software to receive a route advertised 306 by a source network device 304. The route may include the attribute and the at least one network address that may be representative of the source network device 304. The attribute may include the identifier of the source network device 304 and the at least one network address may include the prefix associated with hosts (nodes Z1-100) of the source network device 304. The receiver network device 302 may be further configured to determine a convergence (such as for the alternate routes after convergence upon failure 318) for routing packets from the receiver network device 302 based in part on a determination that the identifier matches at least the prefix of the route advertised by the source network device 304. The receiver network device 302 may be further configured to receive the indication of the failure 314 in the network and to perform the determination of the convergence for routing packets based in part on the indication of a failure in the network.

The receiver network device 302 may be further configured to receive additional advertisements of routes associated with the hosts of the source network device and may be further configured to perform a null process with respect to the additional advertisements from the source network device following the advertisement having the route advertised 306 by the source network device. The receiver network device may be further configured to have an assignment of the NHG for the source network device 302. In one example, the per source NHG module 320 may be enabled with the leaves 202 to perform the NHG assignment. Therefore, any of the network devices of at least the leaves 202 and the spines 204, but also of the super spines 206, may be capable of performing per source NHG determinations using a respective per source NHG module 320. A network having the receiver network device 302 may support individual NHGs for individual network devices. Upon a failure 314, associated with the source network device 304, the receiver network device 302 may be further configured to perform the replacement operation for the NHG and for all prefixes previously associated with the source network device. The replacement operation may be independent of individual updates from the source network device. There may be further NHGs of other source network devices (other leaves 202) in the network that are not part of the failure in the network and these further NHGs may remain unchanged.

Therefore, it is possible to provide a router-identifier logical IP address using a route origin extended community of the BGP for other leaves 202 in a network. The router-identifier logical IP address which has an attached route origin extended community may have a source network device's IP address encoded in the route origin extended community and such an IP address may match the prefix of a route advertised 306, making such a route the router-identifier logical IP address. There may be other routes advertised that may include a route origin extended community but that may have an IP address encoded, in the route origin extended community, that is different from the prefix of the route.

When a network that is compatible with BGP determines a new attribute as part of the route origin extended community, whether it matches or not an IP Address of a route advertised, the BGP may enable individual leaves, spines, and/or other network devices to provide an attribute entry in a Hash table 316B. Routes in the Hash table 316B may be indexed by the attribute. Whenever an attribute entry is created in the Hash table 316B, after processing a route with or without a match in the attribute, a destination entry of that route may be maintained under the attribute entry so that all prefixes that share the same attribute are in one place. This may be used to compute ECMP path comparison for NHG related operations.

An NHG may be created as part of the per source NHG module 320, whenever a routing protocol, such as convergence module 316A, programs a route without an NHG assigned. Then, it is possible to create the per source NHG and to program a route to a kernel of an underlying network device that is part of the NHG. When a network is compliant with BGP, the NHG may be created based at least in part on the identifier in the attribute received. A key for the NHG is value of the identifier received. In one example, the BGP is an owner of an NHG designated by the BGP instead of provided by the per source NHG module 320. The BGP may allocate an NHG for every route and at least for every route having an identifier in an attribute with or without a match in the attribute. The BGP may receive routes in the form of route updates and can use the identifier in the attribute to perform a replacement operation either immediately (in an example of an ECMP shrinking or ECMP weights change) or after a period that may be a predetermined period (in case of ECMP expansion). In addition, BGP may enable withdrawal of a route having the attribute, in which case the NHG associated with such a route or source may be deleted. In a steady state, a scale of NHGs on a switch that may be leaf or a spine may be directly proportional to a number of router-identifier logical IP addresses received. This proportion may be limited by an order of a number of leaves in a network that is capable of exchanging route updates.

The aspects described in FIGS. 1 to 3 herein can provide convergence optimization to improve convergence in routing, upon network events that may include updates, changes, or failures. The network events may include events that may cause a software or system restart a network device (such as a switch, a router etc.). The network events may include events such as a power failure, a hardware failure, or a catastrophic software fault that may cause the links 210 between network devices to fail. Such network events have potential to impact traffic flowing across portions of the network and may require traffic to be re-routed to support alternate routes after convergence upon failure 318. In addition, the convergence optimization herein can make convergence determinations independent of a number of routes that may be impacted by the network event. In one instance, because convergence may be measured by a duration of data traffic lost for traffic towards destinations affected by the network event, the lesser the duration, the better may be the convergence.

The aspects in FIGS. 1 to 3 may include specific application to BGP used as the routing protocol in a network 100, 200, but may be applicable broadly to other routing protocols, and to other types of network compliant with the other routing protocols. In one example, the modules in FIG. 1 to 3 may be for a switch or router to self-identify as a source of routes advertised; to indicate routes that are sourced, in addition with the self-advertising, and to use information received, which may pertain to the self-identification and the self-advertising, to build software and hardware states for network devices. Such states may be unique per source network device. In turn, it is possible to use such states or related information for forwarding received traffic to routes (and to receiver network devices) associated with that source network device. The traffic may be packets of data in one example.

The aspects in FIG. 1 to 3 can also support an ability in switches or routers to prioritize the advertisement. For instance, both of an initial and a subsequent network event may be subject to self-identification of routing information, over other routing information from a same source network device. The aspects in FIG. 1 to 3 also support an ability in the switches or routers to recognize changes to the self-identification using routing information from another switch or router and to perform fast and efficient update of their software and hardware states, and to make the change take effect immediately for all routes (receivers) associated with that route source.

All such aspects may be implemented using BGP or may be provide in a BGP-compliant network and so, the convergence optimization herein is fully conforming with at least the BGP specification. This makes the convergence optimization herein interoperable in a network that may include network devices that do not specifically support the convergence optimization herein. Other network devices that can support the convergence optimization can improve subnets or groups within the network, and the network as a whole. The convergence optimization herein can apply to network devices in a modern datacenter running regular workloads or artificial intelligence/machine learning (AI/ML) workloads, as all such workloads may require traffic to be handled by specialized hardware components (such as application specific integrated circuits (ASICs)). The references to hardware state herein may be in support of such capability in ASICs and other hardware and to not constrain the convergence optimization to specific types of network devices or specific variant of hardware in such network devices.

In some examples, as illustrated in FIG. 3, when a spine, such as spine 21, withdraws hosts Z1-100 from leaf 21, then leaf 21 may receive a BGP delete of a loopback route of leaf 21. This may be using the identifier associated with the leaf. The BGP delete triggers an NHG replace associated with the identifier. In this case, a leaf 21 NHG1 {spine 11, spine 21} may be replaced with {spine 11} so that all hosts Z1-100 prefixes point to leaf 21 NHG1 {spine 11}. There may be no changes with respect to hosts Y1-100 in leaf 12 having an NHG2 {spine 12, spine 22} or hosts P1-100 in leaf 22 having NHG3 {spine 22}. As such, an update is applied to routes including for leaf 21 and spine 21. Such a solution may be applicable to 2 CLOS multiple links between network devices, 3 CLOS single link or multiple links between network devices, and link failures at the leaf, spine, or super spine layers.

In some examples, link failures herein may be addressed when they occur in clos network topologies (such as in 2 CLOS or 3 CLOS), in single or multiple links between network devices, in W-ECMP-based networks or ECMP-based networks, and at different layers (such as leaves, spines, and super-spines). The approaches herein may address convergence to fix an ECMP routes. For prefixes which may be previously learnt on failed links, the ECMP may be adjusted quickly on all the relevant network devices to reflect the change in forwarding based at least in part on changes reflected in a new network topology. Further, in some examples, advertisements may be configured to occur only on leaves. This may be considered as a provision from a source network device as the BGP protocol may allow special processing on the advertised routes under certain configurations, including as described herein. The SOO may be attached to the routes only from the source network device from where a route originated. Once configured, the BGP protocol may attach an SOO to the route origin extended community for all the routes advertised to its peers.

In some examples, redistribution of a route originator ID may occur via a loopback route, from a source network device under the BGP protocol. For example, the redistribution may be advertised using the loopback route over the BGP protocol. The loopback route may be configured with an IPv4 or an IPv6 address that matches the route originator ID. The loopback route may be used to create a per source NHG 320 for faster convergence. The configuration, using the loopback route, may be performed on all switches at all the levels including two or more routes, such as at leaves, spines, and super spines. For example, when the BGP protocol receives a ‘routes with SOO attached’ indication, such as through an extended community, the BGP protocol may allocate a per source NHG 320 which may allow or support the BGP protocol performing a next-hop replace when a link or node changes as part of the change in the network topology. As such, the approaches herein allow programming of a route with an NHG, where ECMP routes may include only the routes as advertised. There may be no explosion of NHGs, when updating ECMP routes to a forwarding plane. In the case of failures, prefix independent convergence is performed to update a forwarding plane, such as all network devices in two or more routes, with new ECMP path independent of number of prefixes present.

In some examples, the SOO may be encoded into the route origin extended community using an IPAddress: NN format, where a high-order octet of the extended communities type field is provided along with a low-order octet of the extended communities type field. When the BGP protocol includes an advertise origin configuration, the IP address portion of SOO may be derived from a router ID withing the network. The last 2 bytes of the SOO may be a fixed hardcoded value in the code. In some examples, whenever the BGP protocol learns of a new SOO, such as by the route origin extended community, an entry may be created in the Hash table or other routing table, such as a route table 316B. In some examples, a route table 316B may be configured for the new SOO. Whenever an SOO entry in the created in a hash table 316B, a destination entry of that route may be maintained under the SOO entry so that all prefixes that share the same SOO are in one place. This is used to compute ECMP path for NHG related operations.

FIG. 4 illustrates computer and processor aspects 400 of a system for convergence optimization using an attribute and at least one network address, according to at least one embodiment. The computer and processor aspects 400 may be performed by one or more processors that include a system-on-a-chip (SOC) or some combination thereof formed with a processor that may include execution units to execute an instruction, according to at least one embodiment. Such one or more processors may include CPUs, data processing units (DPUs), and graphics processing units (GPUs) and may be within a switch 106; 114, any one of different interconnect devices 120, or first or second group nodes 1-N 104A-N; 1-N 112A-N, as described all throughout herein.

In at least one embodiment, the computer and processor aspects 400 may include, without limitation, a component, such as a processor 402 to employ execution units including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS® operating system available from Microsoft® Corporation of Redmond, Wash., although other operating systems (UNIX® and Linux®, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache 404 may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating-point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe®) or some combination thereof. In at least one embodiment, one or more components of the computer and processor aspects 400 that are interconnected using compute express link (CXL) interconnects.

In at least one embodiment, the system in FIGS. 1-4 therefore include one or more execution units 408 in the within a switch 106; 114, any one of different interconnect devices 120, or first or second group nodes 1-N 104A-N; 1-N 112A-N to support convergence optimization. For example, at least one execution unit 408 supports convergence optimization in other processing units of the other host machines (or nodes). The at least one execution unit 408 is part of one or more circuits which are to be associated as nodes in a network. For example, the at least one execution unit 408 of a processor may be a circuit that is to be part of a node with another circuit of another processor in a different node.

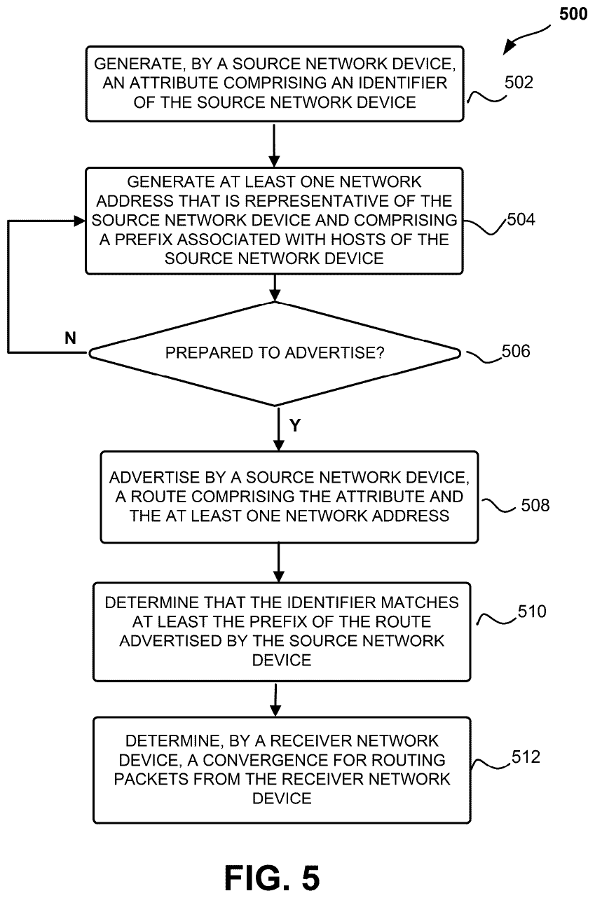

FIG. 5 illustrates a process flow or method 500 in a system for convergence optimization using an attribute and at least one network address, according to at least one embodiment. The method 500 may include generating 502, by a source network device, an attribute including an identifier of the source network device. The method 500 may include generating 504 at least one network address that is representative of the source network device and that includes a prefix associated with hosts of the source network device. The generating 502, 504 steps may be performed at the same or at a different time. The method 500 may include a verification or determination for the source network device being preapred to advertise 506 a route. The method 500 may include advertising 508, by a source network device, a route having the attribute and the at least one network address. The method 500 may include determining 510, by a receiver network device that receives the route, that the identifier matches at least the prefix of the route advertised by the source network device. The method 500 may include determining 512, by the receiver network device, a convergence for routing packets from the receiver network device.

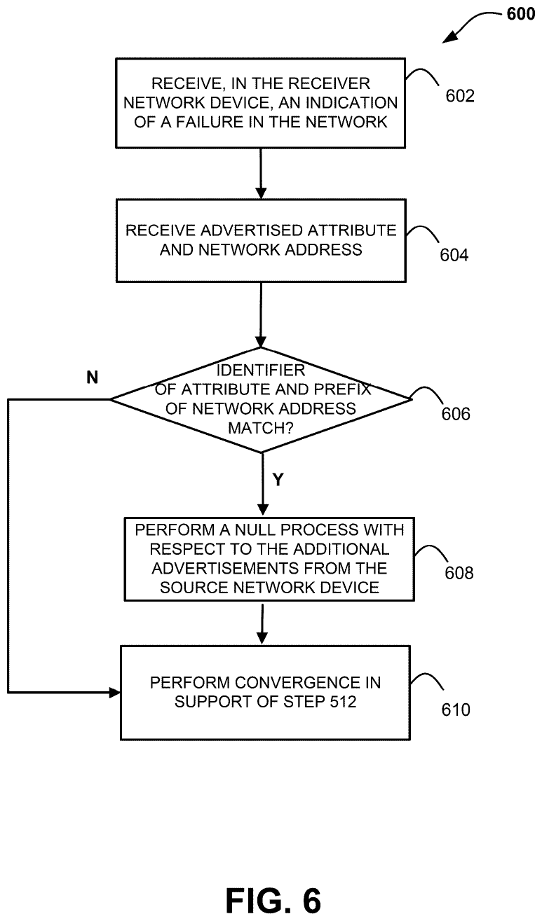

FIG. 6 illustrates yet another process flow or method 600 in a system for convergence optimization using an attribute and at least one network address, according to at least one embodiment. The method 600 may be in support of the method 500 in FIG. 5. For example, the method 600 may include receiving 602, in the receiver network device, an indication of a failure in the network. The method 600 may include receiving 604 the advertised attribute and network address identifier in the route from step 508 in FIG. 5. The method 600 may include determining or verifying that the attribute and prefix of network address match 606. The method 600 may include performing 608 a null process with respect to the additional advertisements from the source network device, upon the match 606 determined. The method 600 may include performing 610 convergence in support of step 512 in FIG. 5. In this manner, only the route having the matching identifier in its attribute, representing the router-identifier logical IP address, may be used for convergence, and which process supports covergence optimization herein.

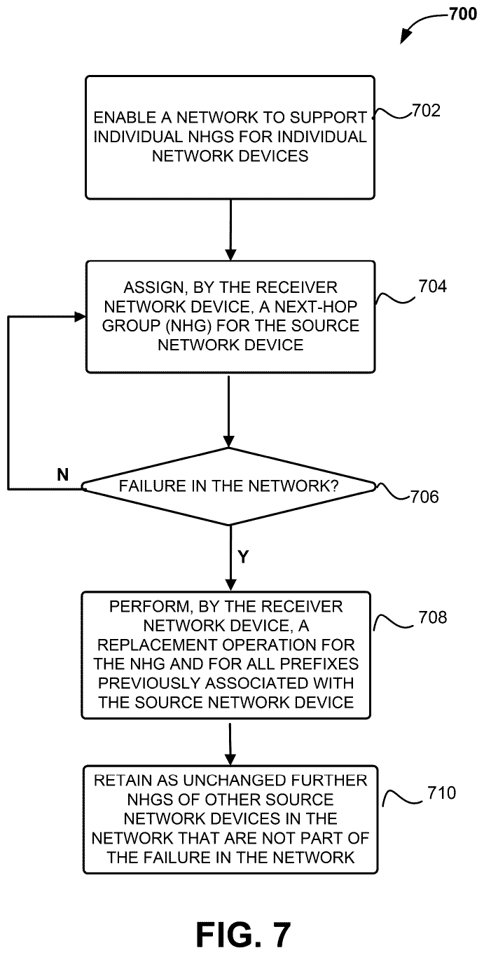

FIG. 7 illustrates a further process flow or method 700 in a system for convergence optimization using an attribute and at least one network address, according to at least one embodiment. The method 700 may be in support of one or more of the method 500 in FIG. 5 or the method 600 in FIG. 6. For example, the method 700 may include enabling 702 a network to support individual NHGs for individual network devices. The method 700 may include assigning 704, by the receiver network device, an NHG for the source network device. The method 700 may include determining or verifying that a failure has occurred in the network 706. This may be by an indication provided to the network devices, by a polling performed by the network devices, or a subscription to a service performed by the network devices. The method 700 may include performing 708, by the receiver network device, a replacement operation for the NHG and for all prefixes previously associated with the source network device. The method 700 may include retaining 710 as unchanged further NHGs of other source network devices in the network that are not part of the failure in the network.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A network comprising a receiver network device and a source network device, the source network device configured to advertise a route comprising an attribute and at least one network address that is representative of the source network device, wherein the attribute comprises an identifier of the source network device and the at least one network address comprises a prefix associated with hosts which are limited in representation by the source network device, and wherein the receiver network device is configured to determine a convergence for routing packets from the receiver network device based in part on a determination that the identifier matches at least the prefix of the route advertised by the source network device.

2. The network of claim 1, wherein the network is compliant with a Border Gateway Protocol (BGP), wherein the attribute is a route origin extended community of the BGP.

3. The network of claim 1, wherein the receiver network device is configured to receive indication of a failure in the network and to perform the determination of the convergence for routing the packets based, at least in part, on the indication of the failure in the network.

4. The network of claim 1, wherein the receiver network device is further configured to receive additional advertisements of routes associated with the hosts of the source network device and is further configured to perform a null process with respect to the additional advertisements from the source network device following an advertisement comprising the route advertised by the source network device, and wherein the null process is to maintain the routing associated with the route comprising the attribute and the at least one network address, without updating to the additional advertisements of routes.

5. The network of claim 1, wherein the receiver network device to further configured to assign a next-hop group (NHG) for the source network device, and wherein the network supports individual NHGs for individual network devices.

6. The network of claim 5, wherein, upon a failure associated with the source network device, the receiver network device is further configured to perform a replacement operation for the NHG and for all prefixes previously associated with the source network device, independent of individual updates from the source network device.

7. The network of claim 6, wherein further NHGs of other source network devices in the network that are not part of the failure in the network remain unchanged.

8. The network of claim 1, wherein the source network device and the receiver network device are leaf network devices, spine network devices, or super spine network devices.

9. A source network device in a network, the source network device configured to advertise a route comprising an attribute and at least one network address that is representative of the source network device, wherein the attribute comprises an identifier of the source network device and the at least one network address comprises a prefix associated with hosts which are limited in representation by the source network device, and wherein the attribute and the at least one network address is to enable a receiver network device in the network to determine a convergence for routing packets from the receiver network device based in part on a determination that the identifier matches at least the prefix of the route advertised by the source network device.

10. The source network device of claim 9, wherein the source network device is part of a network compliant with a Border Gateway Protocol (BGP) and wherein the attribute is a route origin extended community of the BGP.

11. The source network device of claim 9, wherein the source network device is a leaf network device, spine network device, or super spine network device in the network.

12. A receiver network device in a network, the receiver network device configured to receive a route advertised by a source network device, the route comprising an attribute and at least one network address that is representative of the source network device, wherein the attribute comprises an identifier of the source network device and the at least one network address comprises a prefix associated with hosts which are limited in representation by the source network device, and wherein the receiver network device is further configured to determine a convergence for routing packets from the receiver network device based in part on a determination that the identifier matches at least the prefix of the route advertised by the source network device.

13. The receiver network device of claim 12, wherein the receiver network device is further configured to receive indication of a failure in the network and to perform the determination of the convergence for routing the packets based, at least in part, on the indication of the failure in the network.

14. The receiver network device of claim 12, wherein the receiver network device is further configured to receive additional advertisements of routes associated with the hosts of the source network device and is further configured to perform a null process with respect to the additional advertisements from the source network device following an advertisement comprising the route advertised by the source network device.

15. The receiver network device of claim 12, wherein the receiver network device to further configured to assign a next-hop group (NHG) for the source network device, wherein the network supports individual NHGs for individual network devices, wherein, upon a failure associated with the source network device, the receiver network device is further configured to perform a replacement operation for the NHG and for all prefixes previously associated with the source network device independent of individual updates from the source network device, and wherein further NHGs of other source network devices in the network that are not part of the failure in the network remain unchanged.

16. A method for a network, comprising:
generating, by a source network device, an attribute comprising an identifier of the source network device, and at least one network address that is representative of the source network device and comprising a prefix associated with hosts which are limited in representation by the source network device;
advertising, by the source network device, a route comprising the attribute and the at least one network address; and
determining, by a receiver network device, a convergence for routing packets from the receiver network device based in part on a determination that the identifier matches at least the prefix of the route advertised by the source network device.

17. The method of claim 16, wherein the network is compliant with a Border Gateway Protocol (BGP) and wherein the attribute is a route origin extended community of the BGP, and wherein the source network device and the receiver network device are leaf network devices, spine network devices, or super spine network devices in the network.

18. The method of claim 16, further comprising:
receiving, in the receiver network device, an indication of a failure in the network; and
performing the determination of the convergence for routing the packets based, at least in part, on the indication of the failure in the network.

19. One or more circuits to perform convergence within a Border Gateway Protocol (BGP) protocol, the convergence to follow a change in a network topology and to group together two or more routes for hosts, which are limited in representation by an individual leaf switch of a plurality of network devices within the network topology, with a route originator identifier (ID), wherein the route originator ID is used as a basis to update route configuration associated with the plurality of network devices and associated with the two or more routes within the grouping.

20. The one or more circuits of claim 19, wherein the route originator ID is associated with a next-hop group (NHG) which represents the two or more routes, wherein the change in the network topology is to cause a change in the NHG, and wherein the change in the NHG allows the two or more routes under the NHG to be changed to use different ones of the network devices associated with the NHG from an initial ones of the network devices.
